(19) United States
(12) Patent Application Publication
(10) Pub. No.: US 2025/0329939 A1
(43) Pub. Date: Oct. 23, 2025

(54) CASSEGRAIN ANTENNA HAVING A WAVEGUIDE ANTENNA ELEMENT FEED

(71) Applicant: Cambium Networks Ltd, Ashburton (GB)

(72) Inventors: Deepu Vasudevan Nair, Bangalore (IN); Faisalbin N. Abdulmajeed, Bangalore (IN); Jomon Thomas, Bangalore (IN); Varun Hegde, Bangalore (IN)

(73) Assignee: Cambium Networks Ltd, Ashburton (GB)

(21) Appl. No.: 19/178,328

(22) Filed: Apr. 14, 2025

(30) Foreign Application Priority Data
Apr. 23, 2024 (IN) 202441032125

(51) Int. Cl. H01Q 19/19

(52) U.S. Cl. CPC H01Q 19/191

(57) ABSTRACT

A Cassegrain antenna comprises a primary reflector dish, a sub-reflector and a first waveguide antenna element disposed as a feed for the sub-reflector. The first waveguide antenna element comprises a waveguide body having a conductive back plate electrically connected to the waveguide body, a first radiator patch, a second radiator patch, and a first planar substrate carrying a ground plane. The first radiator patch, the second radiator patch and the first planar substrate are disposed within the waveguide body and substantially parallel to the conductive back plate. The ground plane comprises a slot on a first side, the first side being disposed towards the second radiator patch, and the first planar substrate carries a feed track corresponding to the slot on an opposite side of the first planar substrate to the side carrying the ground plane.

### CROSS-REFERENCE TO RELATED APPLICATION

This application claims priority to India patent application Ser. No. 20/244,1032125, filed on Apr. 23, 2024, the entirety of which is hereby fully incorporated by reference herein.

### TECHNICAL FIELD

The present disclosure relates generally to a Cassegrain antenna having a waveguide antenna element feed, and in particular, but not exclusively, to the waveguide antenna feed comprising one or more waveguide bodies having a first and second radiator patch disposed within the waveguide body.

### BACKGROUND

Modern wireless communication networks are typically placed under great demands to provide high data capacity within the constraints of the allocated signal frequency spectrum. To achieve a high data capacity, it is beneficial to transmit and receive signals over a broad frequency band at high signal to noise ratio. To improve signal to noise ratio, directional antennas may be used to maximise gain for a wanted signal and to reject interference from sources having different angles of arrival than the wanted signal. For example, a Cassegrain antenna may be used, in which a feed antenna is used to feed or receive radio frequency transmissions to a sub-reflector. The sub-reflector is used to reflect the signals to or from a primary reflector dish, from which a high gain, narrow beam is formed for transmission or reception from the Cassegrain antenna. A feed horn or other antenna such as a dipole may be used as feed antenna. However, the bandwidth over which the feed antenna provides an effective feed to sub-reflector may be limited, limiting the frequency band over which the Cassegrain antenna may operate effectively.

It would be beneficial to provide a Cassegrain antenna having effective operation over a broad frequency band.

### SUMMARY

In accordance with a first aspect of the present disclosure there is provided a Cassegrain antenna comprising: a primary reflector dish; a sub-reflector; and a first waveguide antenna element disposed as a feed for the sub-reflector, wherein the waveguide antenna element comprises: a waveguide body having a conductive back plate electrically connected to the waveguide body; a first radiator patch; a second radiator patch; and a first planar substrate carrying a ground plane, wherein the first radiator patch, the second radiator patch and the first planar substrate are disposed within the waveguide body and substantially parallel to the conductive back plate of the waveguide body, the first radiator patch being disposed further from the conductive back plate of the waveguide body than the second radiator patch, and the second radiator patch being disposed further from the conductive back plate of the waveguide body than the first planar substrate, and wherein the ground plane comprises a slot on a first side, the first side being disposed towards the second radiator patch, and the first planar substrate carries a feed track corresponding to the slot on an opposite side of the first planar substrate to the side carrying the ground plane.

This arrangement of radiator patches, slots and feed tracks within the waveguide body allows signals over a broad frequency band to be transmitted to and/or received from the sub-reflector with the required beam width to efficiently illuminate the sub-reflector and a broadband impedance match. In an example, signals may be transmitted or received over a band of 4.9-7.2 GHz. The principle of operation is not limited to this frequency band. Other frequency bands, either higher or lower in frequency may be employed in other examples. The arrangement of patches gives a broad impedance match into the waveguide body for signals transmitted to or from the feed tracks.

In an example, the second radiator patch has a width that is greater than the first radiator patch. In an example, the first radiator patch has a width of 0.25-0.5 of a width of the waveguide body and the second radiator patch has a width of 0.3-0.6 of the width of the waveguide body. In another example, the first radiator patch has a width of 0.30-0.40 of a width of the waveguide body and the second radiator patch has a width of 0.35-0.45 of the width of the waveguide body. In an example, the waveguide body has a width of 0.8 wavelengths in air at an operating frequency of the waveguide antenna element.

The dimensions of the first and second radiator patches within the waveguide body according to this disclosure are found to give a broad band impedance match between the feed tracks and the Cassegrain antenna, providing maintenance of antenna gain for the Cassegrain antenna over a broad frequency band.

In an example, the first planar substrate is disposed between 0.1 and 0.3 wavelengths at an operating frequency of the waveguide antenna element from the conductive back plate of the waveguide body. This allows of an effective impedance match for feeding radio frequency signals to or from the second radiator patch.

In an example, the waveguide antenna element comprises a second planar substrate carrying the first radiator patch and a third planar substrate carrying the second radiator patch. The substrate may be epoxy-glass printed circuit board material, for example. The substrates may be supported in the waveguide body by a non-conductive frame. This arrangement provides an effective means of supporting the radiator patches.

In an example, the waveguide body has a rectangular cross-section, in a plane parallel to the conductive back plate. This allows for effective packing of more than one waveguide body as a feed for the sub-reflector to provide for multiple input multiple output (MIMO) operation. In an alternative example, the waveguide body may have a circular cross-section, in a plane parallel to the conductive back plate.

In an example, the waveguide body has parallel sides. This allows for effective packing of more than one waveguide body as a feed for the sub-reflector. In an alternative example, the waveguide body is flared, so that a cross-section further from the conductive back plate has a greater area than a cross-section nearer to the conductive back plate, and the width of the waveguide body is measured at the conductive back plate.

A Cassegrain antenna according to any preceding claim, comprising a second waveguide antenna element disposed as a feed for the sub-reflector, wherein the second waveguide antenna element comprises a second waveguide body. The waveguide antenna element and the second waveguide antenna element may be disposed to radiate in the same direction and the waveguide body and the second waveguide body may comprise a common conductive wall. The second waveguide antenna element allows the Cassegrain antenna to be used for transmission or reception of multiple input multiple output (MIMO) signal formats. The common conductive wall provides for a compact implementation giving a close spacing of feed elements to provide effective MIMO operation.

In an example, the waveguide body and the second waveguide body are disposed so that each antenna element is aligned to radiate in a different direction, to produce respective beams that converge towards the centre of the sub-reflector. This may allow the radiated beam from each waveguide antenna element to more illuminate the sub-reflector more evenly.

In an example, the sub-reflector comprises a conical central section having a diameter less than a combined width of the waveguide body and the second waveguide body. This provides for improved illumination of the primary reflector dish.

In an example, the Cassegrain antenna comprises a non-conductive enclosure configured to enclose the waveguide antenna elements and to attach the sub-reflector to the waveguide antenna elements. The non-conductive enclosure may be configured not to enclose the primary reflector dish. This provides for an effective means to support the sub-reflector while maintaining effective radio frequency performance.

Further features of the present disclosure will be apparent from the following description of preferred embodiments, which are given by way of example only.

### BRIEF DESCRIPTION OF THE DRAWINGS

FIG. 1 is a schematic diagram illustrating an example of a Cassegrain antenna according to this disclosure. In the example shown, the Cassegrain antenna has two waveguide antenna elements disposed as a feed for a sub-reflector.

FIG. 2 is a schematic diagram illustrating an example of a waveguide antenna element according to this disclosure;

FIG. 3 is a schematic diagram illustrating two waveguide antenna elements disposed as a feed for a sub-reflector, in which a first and second waveguide body comprise a common conductive wall;

FIG. 4 is an oblique cross-sectional view of a Cassegrain antenna according to this disclosure;

FIG. 5 is an oblique exploded view of a first, second and third planar substrate and a non-conductive frame configured to hold the substrates within a waveguide body;

FIG. 6 is a side view of a sub-reflector comprising a conical central section;

FIG. 7 is an oblique view of a first and second waveguide body comprising a common conductive wall; and

FIG. 8 is an oblique view of an example of a Cassegrain antenna according to this disclosure connected to a transceiver, in which the non-conductive enclosure is omitted for clarity.

### DETAILED DESCRIPTION

By way of example, embodiments of the present disclosure will now be described in the context of a Cassegrain antenna for operation in frequency band in the region of 4-8 GHZ, and in particular for a band of 4.9-7.2 GHz, but it will be understood that embodiments of the present disclosure are not restricted to operation in this frequency or frequency range, and that Cassegrain antennas according to this disclosure may be designed to operate at higher or lower frequencies. In an example, a Cassegrain antenna having a feed comprising two dual-polar waveguide antenna elements is described, to provide multiple input multiple output (MIMO) operation having 4 radio frequency connections to a MIMO transceiver. Other examples may employ a single waveguide antenna element, or more than two waveguide antenna elements, for example 3, 4 or more waveguide antenna elements.

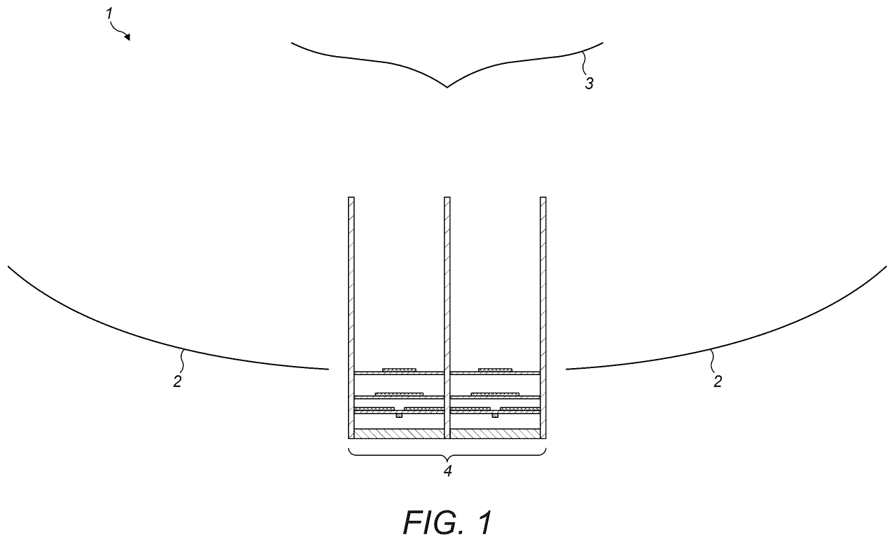

FIG. 1 is a schematic diagram (not to scale) illustrating an example of a Cassegrain antenna 1 according to this disclosure, having two waveguide antenna elements disposed as a feed 4 for a sub-reflector 3 and a primary reflector dish 2. The waveguide antenna elements are configured to form a transmit or receive beam of radio frequency signals towards the sub-reflector 3, and the sub-reflector 3 is configured to reflect the beam towards the primary reflector dish 2. The Cassegrain antenna may be used to transmit or receive radio frequency signals.

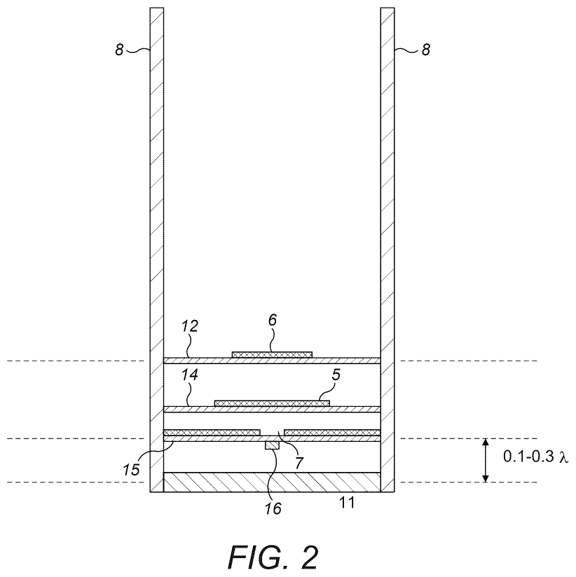

FIG. 2 is a schematic diagram illustrating an example of a waveguide antenna element. The waveguide antenna element comprises a waveguide body 8 having a conductive back plate, a first radiator patch 6, a second radiator patch 5 and a first planar substrate 15 carrying a ground plane. The waveguide body is a hollow electrically conductive tube, in this example having a square cross-section. The open end of the waveguide body radiates and/or receives radiation.

The first radiator patch 6, the second radiator patch 5 and the first planar substrate 15 are disposed within the waveguide body 8 and substantially parallel to the conductive back plate of the waveguide body 8. The first radiator patch 6 is disposed further from the conductive back plate of the waveguide body 8 than the second radiator patch 5. The second radiator patch 5 is disposed further from the conductive back plate of the waveguide body than the first planar substrate 15. A radiator patch is typically planar and composed of a conductive material such as copper, and may be conveniently formed as an etched shape, typically a square, on a printed circuit board.

The ground plane on the first planar substrate 15 comprises a slot 7 on a first side, the first side being disposed towards the second radiator patch 5. The first planar substrate 15 carries a feed track 16 corresponding to the slot 7 on the opposite side of the first planar substrate 15 to the side carrying the ground plane. The feed track 16 may be connected to a radio transceiver, so that radio frequency signals may be transmitted by or received by the transceiver via the Cassegrain antenna. The feed track 16 may in an example be a microstrip track with a nominal impedance of 50 Ohm, connected to a terminal of the transceiver also having a nominal impedance of 50 Ohm. For optimum gain the feed track should be impedance matched over a broad frequency band to the radiator patches of the Cassegrain antenna, through the slot, and from the radiator patches via the sub-reflector and the main reflector dish to free space. The arrangement of radiator patches, slots and feed tracks within the waveguide body according to this disclosure allows signals over a broad frequency band to be transmitted to and/or received from the sub-reflector with the required beam width to efficiently illuminate the sub-reflector and the primary reflector dish with a broadband impedance match. In an example, signals may be transmitted or received over a band of 4.9-7.2 GHz. The width of the beam is substantially determined by the radiation characteristics of the open end of the waveguide body. The arrangement of patches gives a broad impedance match into the waveguide body for signals transmitted to or from the feed tracks.

In the example illustrated by FIG. 2, example, the first planar substrate 15 is disposed between 0.1 and 0.3 of a wavelength, in this example a quarter of a wavelength, at an operating frequency of the waveguide antenna element from the conductive back plate of the waveguide body. 8. This allows of an effective impedance match for feeding radio frequency signals to or from the second radiator patch 5 via the slot 7 in the ground plane.

As illustrated by FIG. 2, the waveguide antenna element comprises a second planar substrate 12 carrying the first radiator patch 6 and a third planar substrate 14 carrying the second radiator patch 5. The substrates may be epoxy-glass printed circuit board material, such as FR4, for example, or in other examples, other non-conductive materials may be used.

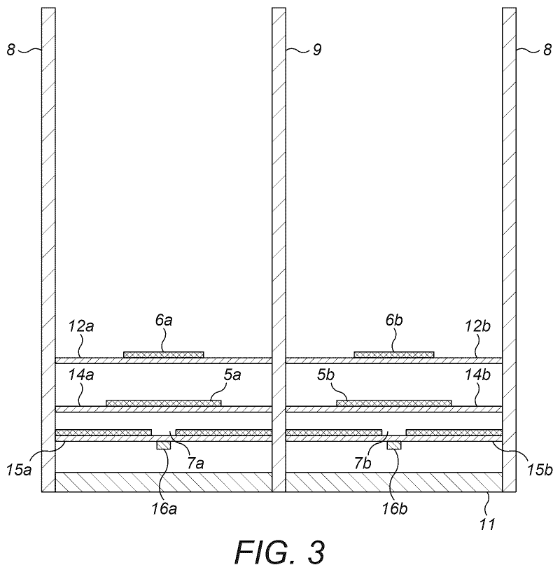

FIG. 3 is a schematic diagram illustrating two waveguide antenna elements disposed as a feed for a sub-reflector, in which the waveguide antenna elements are disposed to radiate in the same direction and in which a first and second waveguide body comprise a common conductive wall 9. In the example shown, each waveguide antenna element has a similar structure to that shown in FIG. 2, having a respective first radiator patch 6a, 6b, a respective second radiator patch 5a, 5b, and a respective first planar substrate 15a, 15b, each having a feed track 16a, 16b and a slot 7a, 7b in a ground plane carried on one side of the first planar substrate 15a, 15b. The waveguide bodies have a conductive back plate 11. The conductive back plate 11 may be made as a separate piece from the remainder of the waveguide bodies or as one piece. The waveguide bodies and conductive back plate 11 are made from an electrically conductive material, for example aluminium.

As shown in FIG. 3, a planar substrates 15a, 15b is disposed within the waveguide bodies 8. In an alternative arrangement, the planar substrates may be parts of a printed circuit board that connects one of more planar substrates together and separates the waveguide body from the conductive back plate. Electrical connections, such as rows of plated-through holes, are provided on the printed circuit board to connect the waveguide bodies electrically to the conductive back plate.

The first and second waveguide antenna elements are disposed as a feed for the sub-reflector as shown in FIG. 1. The first and second waveguide antenna elements allow the Cassegrain antenna to be used for transmission or reception of multiple input multiple output (MIMO) signal formats. The common conductive wall 9 provides for a compact implementation giving a close spacing of feed elements to provide effective MIMO operation. More than two waveguide bodies may be used as feeds for the sub-reflector to provide higher order MIMO operation, that is to say MIMO using a greater number of antenna elements. Each patch radiator may be arranged to be fed by two feed tracks, each feed track feeding the radiator patch by a respective slot in the ground plane. This provides for dual polar operation of each waveguide body, each polarisation providing an additional antenna element for use in MIMO transmission or reception.

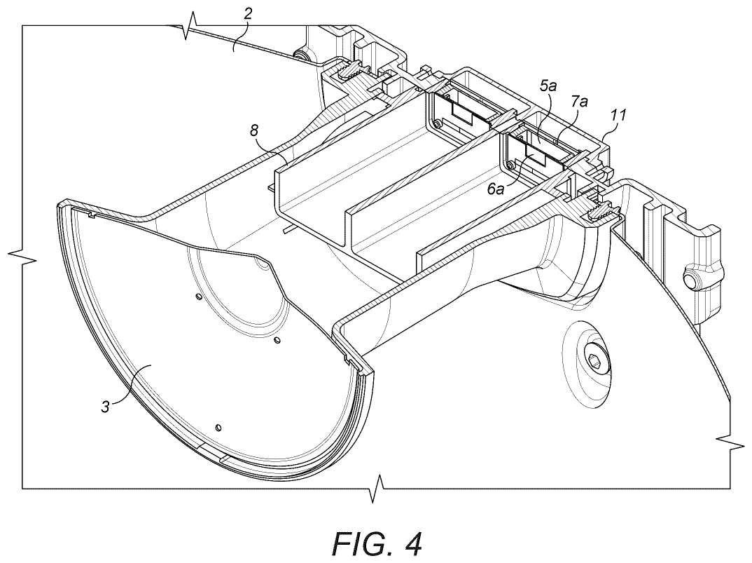

FIG. 4 is an oblique cross-sectional view of a Cassegrain antenna according to this disclosure, showing the waveguide bodies 8, and first 6a and second 5a a radiator patches and the conductive back plate of the waveguide bodies 11, in this example made as a separate piece from the remainder of the waveguide bodies 8 and electrically connected to the waveguide bodies 8. It can be seen from FIG. 4 that the Cassegrain antenna comprises a non-conductive enclosure enclosing the waveguide bodies 8 of the waveguide antenna elements and attaching the sub-reflector 3 to the waveguide antenna elements. The non-conductive enclosure in this example does not enclose the primary reflector dish 2. This provides for an effective means to support the sub-reflector while maintaining effective radio frequency performance.

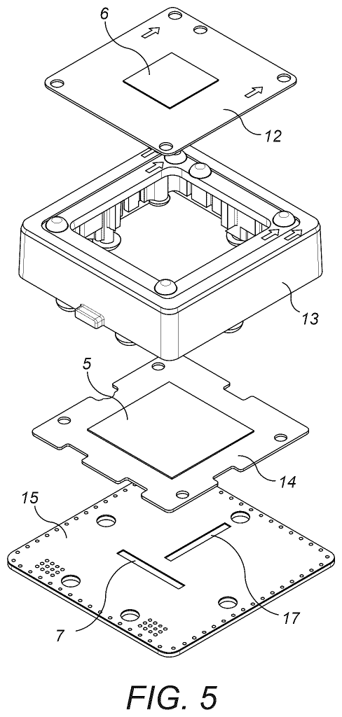

FIG. 5 is an oblique exploded view of a first 15, second 12 and third 14 planar substrate and a non-conductive frame 13, for example made form a plastic or composite material, configured to hold the substrates within a waveguide body. In an example, the second radiator patch has a width that is greater than the first radiator patch. In an example, the first radiator patch has a width of 0.25-0.5 of a width of the waveguide body and the second radiator patch has a width of 0.3-0.6 of the width of the waveguide body. In another example, the first radiator patch has a width of 0.30-0.40 of a width of the waveguide body and the second radiator patch has a width of 0.35-0.45 of the width of the waveguide body. In an example, the waveguide body has a width of 0.8 wavelengths in air at an operating frequency of the waveguide antenna element. In a specific example, the first planar substrate extends for the width of the waveguide body, and has dimensions of 42×42 mm, the width of the waveguide body, as an inside dimension, being 42 mm in this example. The first radiator patch measures, in this example, 14.8×14.8 mm, and the second radiator patch measures, in this example, 16.4×16.4 mm. At an operating frequency of 6 GHZ, the width of the waveguide body is approximately 0.8 wavelengths in air. In this example, the thickness of the first planar substrate is 0.3 mm, and the thickness of the second and third planar substrates is 0.5 mm.

It has been found that the arrangement and dimensions of the radiator patches within the waveguide bodies according to this disclosure give a particularly broad band impedance match from the feed tracks to the Cassegrain antenna, providing broad band antenna gain.

As shown in FIG. 5, two slots 7, 17 may be provided in the ground plane carried on the first planar substrate, for feeding respective polarisations of two orthogonal polarisations, nominally vertical and horizontal polarisations. For each slot, a respective feed track is provided on the opposite side of the planar substrate form the ground plane. Each feed track is aligned with the respective slot. The feed track is provided for connection of signals to or from a radio frequency transceiver, via the slot, to the second radiator patch, the first radiator patch, and then for radiation to or from the open end of the waveguide body. Each feed track, in this example, is arranged to run directly under the slot lengthways along the slot, the end of the feed track being located mid-way along the slot.

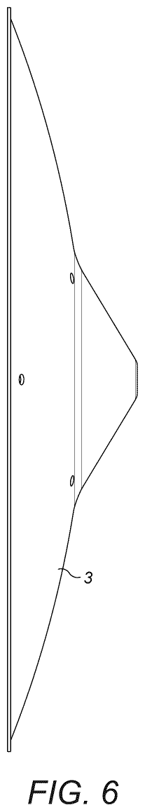

FIG. 6 is a side view of a sub-reflector 3 according to this disclosure. It can be seen that the sub-reflector 3 comprises a conical central section. As may be seen from FIG. 4, the conical central section has a diameter less than a combined width of the waveguide bodies 8 used to feed the sub-reflector 3. The conical central section is configured to reflect signals radiated from the open ends of the waveguide bodies to the primary reflector dish 2, avoiding reflection back into the waveguide bodies. This provides improved antenna gain for the Cassegrain antenna and improves impedance match.

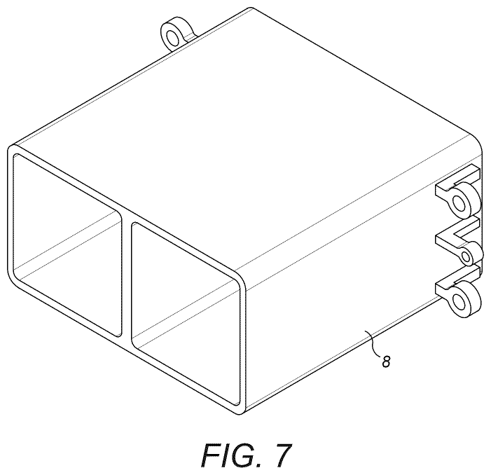

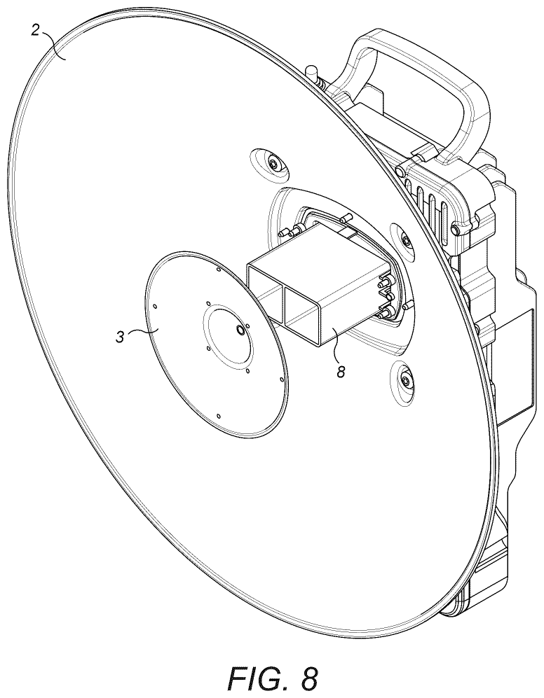

FIG. 7 is an oblique view of a first and second waveguide body 8 and FIG. 8 is an oblique view of an example of a Cassegrain antenna according to this disclosure connected to a transceiver, in which the non-conductive enclosure is omitted for clarity. The waveguide body 8, sub-reflector 3 and primary reflector dish 2 are shown.

In the example described, the waveguide body 8 has a rectangular cross-section, in a plane parallel to the conductive back plate, and the waveguide body has parallel sides. This allows for effective packing of more than one waveguide body as a feed for the sub-reflector to provide for multiple input multiple output (MIMO) operation. For example, 3, 4 or more waveguide antenna elements may be used, providing for MIMO transmission or reception having 6, 8 or more MIMO elements, including for example two polarisations per waveguide antenna element. The waveguide antenna elements may be arranged as a compact feed arrangement, in which the waveguide bodies are adjacent to each other. The waveguide bodies may be formed as a single metallic piece for example, for example as a single casting, for example from aluminium. The compact arrangement reduces obstruction of radiofrequency waves reflected form the sub-reflector to the primary reflector dish.

In an alternative example, the waveguide body may have a circular cross-section, in a plane parallel to the conductive back plate. In alternative examples, the waveguide body may flared, so that a cross-section further from the conductive back plate has a greater area than a cross-section nearer to the conductive back plate. This may provide a modified radiation pattern from the open end of the waveguide body if required for a specific arrangement with respect to the position of the sub-reflector.

In an alternative example, the waveguide body and the second waveguide body are disposed so that each antenna element is aligned to radiate in a different direction, to produce respective beams that converge towards the centre of the sub-reflector. This may allow for more even illumination of the sub-reflector and may allow for a reduced size of sub-reflector.

In an alternative example, there may be only one patch radiator per waveguide body. This provides a simplified construction. In another alternative, the patches may be omitted altogether, so that each slot feeds the waveguide body directly. There may be one slot for each orthogonal polarisation.

The above embodiments are to be understood as illustrative examples of the present disclosure. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What we claim is:

1. A Cassegrain antenna comprising:
a primary reflector dish;
a sub-reflector; and
a first waveguide antenna element disposed as a feed for the sub-reflector,
wherein the first waveguide antenna element comprises:
a waveguide body having a conductive back plate electrically connected to the waveguide body;
a first radiator patch;
a second radiator patch; and
a first planar substrate carrying a ground plane,
wherein the first radiator patch, the second radiator patch and the first planar substrate are disposed within the waveguide body and substantially parallel to the conductive back plate, the first radiator patch being disposed further from the conductive back plate of the waveguide body than the second radiator patch, and the second radiator patch being disposed further from the conductive back plate than the first planar substrate, and
wherein the ground plane comprises a slot on a first side, the first side being disposed towards the second radiator patch, and the first planar substrate carries a feed track corresponding to the slot on an opposite side of the first planar substrate to a side carrying the ground plane.

2. The Cassegrain antenna of claim 1,
wherein the second radiator patch has a width that is greater than the first radiator patch.

3. The Cassegrain antenna according of claim 1, wherein the first radiator patch has a width of 0.25-0.5 of a width of the waveguide body and the second radiator patch has a width of 0.3-0.6 of the width of the waveguide body.

4. The Cassegrain antenna of claim 1, wherein the first radiator patch has a width of 0.30-0.40 of a width of the waveguide body and the second radiator patch has a width of 0.35-0.45 of the width of the waveguide body.

5. The Cassegrain antenna of claim 1,
wherein the waveguide body has a width of 0.8 wavelengths in air at an operating frequency of the first waveguide antenna element.

6. The Cassegrain antenna of claim 1,
wherein the first planar substrate is disposed between 0.1 and 0.3 wavelengths at an operating frequency of the first waveguide antenna element from the conductive back plate.

7. The Cassegrain antenna of claim 1,
wherein the first waveguide antenna element comprises a second planar substrate carrying the first radiator patch and a third planar substrate carrying the second radiator patch.

8. The Cassegrain antenna of claim 7,
wherein the waveguide body comprises a non-conductive frame configured to hold the second and third planar substrates within the waveguide body.

9. The Cassegrain antenna of claim 1,
wherein the waveguide body has a rectangular cross-section, in a plane parallel to the conductive back plate.

10. The Cassegrain antenna of claim 1, wherein the waveguide body has a circular cross-section, in a plane parallel to the conductive back plate.

11. The Cassegrain antenna of claim 1,
wherein the waveguide body has parallel sides.

12. The Cassegrain antenna of claim 1,
wherein the waveguide body is flared, so that a cross-section further from the conductive back plate has a greater area than a cross-section nearer to the conductive back plate, and a width of the waveguide body is measured at an end of the waveguide body nearer to the conductive back plate.

13. The Cassegrain antenna of claim 1, comprising a second waveguide antenna element disposed as a feed for the sub-reflector. wherein the second waveguide antenna element comprises a second waveguide body.

14. The Cassegrain antenna of claim 13, wherein the first waveguide antenna element and the second waveguide antenna element are disposed to radiate in a same direction and the waveguide body and the second waveguide body comprise a common conductive wall.

15. The Cassegrain antenna of claim 13, wherein the waveguide body and the second waveguide body are disposed so that each antenna element is aligned to radiate in a different direction, to produce respective beams that converge towards a centre of the sub-reflector.

16. The Cassegrain antenna of claim 13,
wherein the sub-reflector comprises a conical central section having a diameter less than a combined width of the waveguide body and the second waveguide body.

17. The Cassegrain antenna of claim 13,
comprising a non-conductive enclosure configured to enclose the waveguide antenna elements and to attach the sub-reflector to the waveguide antenna elements.

18. The Cassegrain antenna of claim 17, wherein
the non-conductive enclosure is configured not to enclose the primary reflector dish.
